(19) United States
(12) Patent Application Publication
(10) Pub. No.: US 2015/0315022 A1
(43) Pub. Date: Nov. 5, 2015

(54) CONTACT APPARATUS FOR OXIDIZING SULFUR DIOXIDE AND SYSTEMS FOR PRODUCING SULFURIC ACID

(71) Applicant: Chemetics Inc., Vancouver (CA)

(72) Inventor: Orlando Perez, Burnaby (CA)

(21) Appl. No.: 14/651,147

(22) PCT Filed: Dec. 10, 2013
(86) PCT No.: PCT/CA2013/050947

§ 371 Date: Jun. 10, 2015

Related U.S. Application Data
(60) Provisional application No. 61/738,369, filed on Dec. 17, 2012.

(51) Int. Cl. C01B 17/76; B01J 19/00; C01B 17/80

(52) U.S. Cl. CPC C01B 17/76; C01B 17/806; B01J 19/0013; B01J 2219/00081; B01J 2219/24

(57) ABSTRACT

A method is disclosed for oxidizing sulfur dioxide using the contact process in which a gas stream comprising the sulfur dioxide and oxygen itself is used as the cooling medium in a contact apparatus comprising a double pipe heat exchanger. In associated systems for producing sulfuric acid, certain heat exchangers can be omitted thereby allowing for simpler and less expensive systems. The invention is suitable for systems using either a single or, in particular, a double absorption process. Further, the invention is suitable in new systems or in a retrofit of existing systems.

### TECHNICAL FIELD

The present invention pertains to methods for oxidizing sulphur dioxide according to the contact process and for producing sulphuric acid thereafter. It also pertains to contact apparatus and systems used in such methods.

### BACKGROUND

Sulfuric acid is one of the most produced commodity chemicals in the world and is widely used in the chemical industry and commercial products. Generally, production methods involve converting sulphur dioxide first to sulphur trioxide which is then later converted to sulphuric acid. In 1831, P. Phillips developed the contact process which is used to produce most of today's supply of sulphuric acid.

The basics of the contact process involve obtaining a supply of sulphur dioxide (e.g. commonly obtained by burning sulphur) and then oxidizing the sulphur dioxide with oxygen in the presence of a catalyst (typically vanadium oxide) to accelerate the reaction in order to produce sulphur trioxide. The reaction is reversible and exothermic and it is important to appropriately control the temperature of the gases over the catalyst in order to achieve the desired conversion without damaging the contact apparatus which comprises the catalyst.

Then, the produced sulphur trioxide is absorbed into a concentrated sulphuric acid solution to form oleum, which is then diluted to produce another concentrated sulphuric acid solution. This avoids the consequences of directly dissolving sulphur trioxide into water which is a highly exothermic reaction.

While the fundamentals of the contact process are relatively simple, it is desirable to maximize the conversion of sulfur dioxide into sulphuric acid and to minimize the energy requirements involved. Thus, modern plants for producing sulphuric acid often involve more than one absorption stage to improve conversion and absorption and the plants often involve complex heat exchanger arrangements to improve energy efficiency. Commonly, a double absorption process is employed in which process gases are subjected to two contact and absorption stages in series, (i.e. a first catalytic conversion and subsequent absorption step followed by a second catalytic conversion and absorption step). Details regarding the conventional options available and preferences for sulphuric acid production and the contact process are well known and can be found for instance in “Handbook of Sulfuric Acid Manufacturing”, Douglas Louie, ISBN 0-9738992-0-4, 2005, published by DKL Engineering, Inc., Ontario, Canada.

Improvements continue to be developed in the art in order to improve on the industrial contact process for making sulphuric acid. For instance, U.S. Pat. No. 7,871,593 discloses a process for the continuous catalytic complete or partial oxidation of a starting gas containing from 0.1 to 66% by volume of sulphur dioxide plus oxygen, in which the catalyst is kept active by means of pseudoisothermal process conditions with introduction or removal of energy. Apparatus for the continuous catalytic complete or partial oxidation of a starting gas containing sulphur dioxide and oxygen having at least one tube contact apparatus is disclosed in the form of an upright heat exchanger composed of at least one double-walled tube whose catalyst-filled inner tube forms a reaction tube. Heat is transferred in cocurrent fashion around the reaction tube using an externally supplied cooling medium (such as air). Objects of the invention were to make possible the inexpensive preparation of sulphuric acid for concentrated starting gases having sulphur dioxide contents of >13.5% by volume and also to provide an economically ecological process for sulphur dioxide-containing offgases from various chemical processes. Embodiments of both double and single absorption arrangements were depicted in several simplified schematics. Presumably for simplicity however many necessary components were omitted in these figures, including many of the numerous additional heat exchangers required in order to achieve a desired near-complete conversion of sulphur dioxide.

Also for instance, WO2011/137506 discloses an improved gas-gas shell and tube heat exchanger suitable for use in sulfuric acid plants. The heat exchanger comprises both a section of co-current flow and a section of counter-current flow for heat exchange and provides increased minimum tube wall temperature within the exchanger for given process conditions while maintaining a high log mean temperature differential allowing for the prevention of corrosion from entrained corrosive vapours or entrained corrosive mist with a minimal increase in effective area.

There remains however a desire for yet further improvements in conversion, energy efficiency, and cost reduction in the industrial production of sulphuric acid. The present invention addresses this desire and provides other benefits as disclosed below.

### SUMMARY

In the present invention, the process gas stream containing the sulphur dioxide is itself used as the cooling media for the contact process. Appropriate configuration of the associated contact apparatus used in a system for producing sulphuric acid not only provides for acceptable cooling of the contact catalyst material but also for a desirable heating of the process gas stream. The cooling air or other cooling media used in conventional systems can thus be omitted along with any hardware specific for an external supply of cooling media. Further still, certain other heat exchangers found in conventional systems, which are required in order to achieve high conversion efficiency, can also be omitted. Consequently, the overall system can be simplified, and energy and capital cost benefits can be obtained.

Specifically, a method and contact apparatus are provided for oxidizing sulfur dioxide in a gas stream comprising sulfur dioxide and oxygen at a supply temperature. The method comprises providing a first contact apparatus comprising a double pipe heat exchanger comprising an inner pipe comprising a first contact catalyst mass, and an essentially concentric outer pipe. Further, the method comprises exchanging heat with the gas stream to adjust the gas stream to a first contact apparatus inlet temperature, flowing the gas stream between the inner and outer pipes of the double pipe heat exchanger, and then collecting the gas stream exiting from between the inner and outer pipes and flowing the gas stream countercurrently through the inner pipe of the double pipe heat exchanger. In the method, the sulfur dioxide containing gas stream is the cooling medium for the first contact apparatus and is heated to a catalyst activation temperature as it flows between the inner and outer pipes, and is then heated, as a result of the reactions taking place within, to a first contact apparatus outlet temperature as it flows through the inner pipe. Further, as a result of the reactions taking place within, a portion of the sulfur dioxide in the inner pipe is oxidized to sulfur trioxide.

In the method, the gas stream supply temperature can be in the range from about 130 to 250° C. Further, the first contact apparatus inlet temperature can be in the range from about 130 to 250° C. The catalyst activation temperature can be in the range from about 385 to 425° C. And the first contact apparatus outlet temperature can be in the range from about 450 to 500° C.

An embodiment of contact apparatus suitable for use in the inventive method comprises a double pipe heat exchanger comprising an inner pipe comprising a contact catalyst mass, and an essentially concentric outer pipe, wherein the contact apparatus is configured to operate according to the method, namely for countercurrent exchange.

In a preferred embodiment, the double pipe heat exchanger in the contact apparatus can comprise helical fins and studs between the inner and outer pipes. In addition, the inner pipe of the double pipe heat exchanger can comprise a plurality of cartridges in series wherein the cartridges comprise the contact catalyst mass. Each cartridge comprises an outer perforated tube and an inner hollow mandrel in which the contact catalyst mass is located between the perforated tube and the mandrel. Each cartridge can also comprise a helical insert between the perforated tube and the mandrel. Use of a series of cartridges can be advantageous for ease of handling and/or loading. Further, catalyst gradients can be readily established for instance if the contact catalyst masses in different cartridges from the plurality of cartridges are characterized by a different parameter selected from the group consisting of packing density, porosity, and catalyst size.

In an exemplary industrial embodiment, the contact apparatus can comprise a plurality of double pipe heat exchangers. In particular, the plurality of double pipe heat exchangers can be arranged in parallel.

The invention is suitable for both single and double absorption processes for oxidizing sulfur dioxide to produce sulfuric acid. The single absorption process comprises providing a gas stream comprising sulfur dioxide and oxygen at a supply temperature, and oxidizing sulfur dioxide in the gas stream according to the preceding contact method in which the sulfur dioxide containing gas stream is the cooling medium for the contact process. To adjust the gas stream to the first contact apparatus inlet temperature, heat is exchanged between the gas stream and a cold exchanger gas in a cold exchanger in the exchanging heat step. In the single absorption process, heat is exchanged between the gas stream at the first contact apparatus outlet temperature and a sulfur trioxide cooler gas in a sulfur trioxide cooler in which the gas stream is. cooled to a second contact apparatus inlet temperature. Further, the sulfur dioxide in the, gas stream at the second contact apparatus inlet temperature is oxidized in a second contact apparatus comprising a second contact catalyst mass, in which sulfur dioxide in the second contact apparatus is oxidized to sulfur trioxide, and the gas stream is heated to a second contact apparatus outlet temperature. Further still, heat is exchanged between the gas stream at the second contact apparatus outlet temperature and the gas stream at the supply temperature in the cold exchanger in which the gas stream at the second contact apparatus outlet temperature is the cold exchanger gas, thereby cooling the portion of the gas stream to an absorption tower inlet temperature. And further still, the gas stream at the absorption tower inlet temperature is directed to an absorption tower in which sulfur trioxide in the combined gas stream is absorbed in water to produce sulfuric acid. Finally, the gas stream is exhausted, for instance to a stack or scrubber. An advantage of the inventive single absorption process is that the process need not involve any additional heat exchanging steps in additional heat exchangers.

The related double absorption process also comprises providing a gas stream comprising sulfur dioxide and oxygen at a supply temperature, and oxidizing sulfur dioxide in the gas stream according to the preceding contact method in which the sulfur dioxide containing gas stream is the cooling medium for the contact process. Again, heat is exchanged between the gas stream and a cold exchanger gas in a cold exchanger in the exchanging heat step. In the double absorption process though, heat is exchanged between the gas stream at the first contact apparatus outlet temperature and a cold reheat exchanger gas in a cold reheat exchanger in which the gas stream is cooled to an intermediate absorption tower inlet temperature. Further, the gas stream at the intermediate absorption tower inlet temperature is directed to an intermediate absorption tower in which sulfur trioxide in the gas stream is absorbed in water to produce sulfuric acid and the gas stream is cooled to an intermediate absorption tower outlet temperature. Further still, heat is exchanged between the gas stream at the intermediate absorption tower outlet temperature and both the gas stream at the first contact apparatus outlet temperature and the gas stream at a second contact apparatus outlet temperature in the cold reheat exchanger. Here, the gas stream at the intermediate absorption tower outlet temperature is the cold reheat exchanger gas. This results in the gas stream being heated to a second contact apparatus inlet temperature. Further still, the sulfur dioxide in the gas stream at the second contact apparatus inlet temperature is oxidized in a second contact apparatus comprising a second contact catalyst mass, in which sulfur dioxide in the second contact apparatus is oxidized to sulfur trioxide, and the gas stream is heated to the second contact apparatus outlet temperature. And further, heat is exchanged between a portion of the gas stream at the second contact apparatus outlet temperature and the gas stream at the supply temperature in the cold exchanger. Here, the portion of the gas stream at the second contact apparatus outlet temperature is the cold exchanger gas. This results in the portion of the gas stream being cooled to a cooled portion temperature. Further still, heat is exchanged between the remaining portion of the gas stream at the second contact apparatus outlet temperature and the gas stream at the intermediate absorption tower outlet temperature in the cold reheat exchanger, thereby cooling the remaining portion of the gas stream to a cooled remaining portion temperature. Further still, the portion of the gas stream at the cooled portion temperature and the remaining portion of the gas stream at the cooled remaining portion temperature are combined such that the combined gas stream is at a final absorption tower inlet temperature. And further, the combined gas stream at the final absorption tower inlet temperature is directed to a final absorption tower in which sulfur trioxide in the combined gas stream is absorbed in water to produce sulfuric acid. Finally, the gas stream is exhausted as in the single absorption process. As above, an advantage of the inventive double absorption process is that the process need not involve any additional heat exchanging steps in additional heat exchangers.

In one embodiment of the double absorption process, both the portion and the remaining portion of the gas stream at the second contact apparatus outlet temperature are in the range from about 410 to 450° C. And, the portion of the gas stream at the cooled portion temperature is in the range from about 180 to 230° C.

A related system for oxidizing sulfur dioxide to produce sulfuric acid according to the aforementioned single absorption process comprises a cold exchanger, a first contact apparatus comprising a first contact catalyst mass, a sulfur trioxide cooler, a second contact apparatus comprising a second contact catalyst mass, and an absorption tower, in which the system is configured to operate according to the single absorption process.

In a like manner, a related system for oxidizing sulfur dioxide to produce sulfuric acid according to the aforementioned double absorption process comprises a cold exchanger, a first contact apparatus comprising a first contact catalyst mass, a cold reheat exchanger, an intermediate absorption tower, a second contact apparatus comprising a second contact catalyst mass, and a final absorption tower, in which the system is, configured to operate according to the double absorption process.

In exemplary embodiments, the second contact apparatus can comprise a bed supporting the second contact catalyst mass. Alternatively, the second contact apparatus can instead comprise a pipe comprising a plurality of cartridges in series in which the cartridges comprise the second contact catalyst mass. Also in exemplary embodiments, the first contact apparatus can preferably be oriented horizontally.

In a preferred embodiment of a system for oxidizing sulfur dioxide to produce sulfuric acid according to the aforementioned double absorption process, the cold reheat exchanger employed can comprise a shell and tube heat exchanger comprising a co-current flow section for the heat exchanging of the gas stream at the first contact apparatus outlet temperature and a counter-current flow section for the heat exchanging of the remaining portion of the gas stream at the second contact apparatus outlet temperature.

### BRIEF DESCRIPTION OF THE DRAWINGS

FIG. 1 shows an isometric view of a cartridge comprising contact catalyst mass.

FIG. 2 shows a cross-sectional view of a contact apparatus comprising a plurality of double pipe heat exchangers in which the inner pipes of each heat exchanger contains a plurality of the cartridges shown in FIG. 1.

FIG. 3a shows a schematic of a prior art double absorption system for producing sulphuric acid.

FIG. 3b shows a schematic of a double absorption system of the invention for producing sulphuric acid in which the system comprises the contact apparatus of FIG. 2.

FIG. 4 shows a schematic of a single absorption system of the invention for producing sulphuric acid in which the system comprises the contact apparatus of FIG. 2.

FIG. 5 illustrates how the temperatures of the gas streams are expected to change with the conversion of sulphur dioxide therein in the comparative and inventive double absorption systems in the Examples.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and are not limited to just one.

In a numerical context, the word “about” is to be construed as meaning plus or minus 10%.

In conventional contact processes, the adiabatic oxidation of SO₂ is limited to concentrations of about 12% SO₂ in the supplied gas stream due to temperature limitations on the current materials of construction, and the processes require multiple heat exchangers to maximize conversion. In the present invention, a simple contact apparatus is employed in order to pseudo-isothermally oxidize SO₂ and it provides an alternative process for oxidizing higher concentrations of SO₂ using with fewer heat exchangers in the overall system. In this contact apparatus, the gas stream comprising SO₂ itself is used as the cooling medium. Material of construction limitations are not an issue since the heat of oxidation is constantly removed by the incoming process gas.

The contact apparatus uses a double pipe heat exchanger comprising an inner tube and an essentially concentric outer pipe. The inner tube contains the catalyst mass to pseudo-isothermally oxidize SO₂. A cold gas stream comprising unoxidized SO₂ enters the annular space between the two pipes at one end (the hot end), is collected after exiting at the other end (the cold end), and is then directed to flow countercurrently through the inner pipe. SO₂ in the gas stream is oxidized as it flows over the catalyst mass in the inner pipe and heat from the exothermic oxidation reaction is continuously removed by the gas stream flowing in the annular space between the pipes. The continuous removal of heat obviates the need for a conventional “hot exchanger” and “inter reheat exchanger” in a conventional contact system, and also makes it possible to process gas streams with higher than conventional concentrations of SO₂ (i.e. >12%).

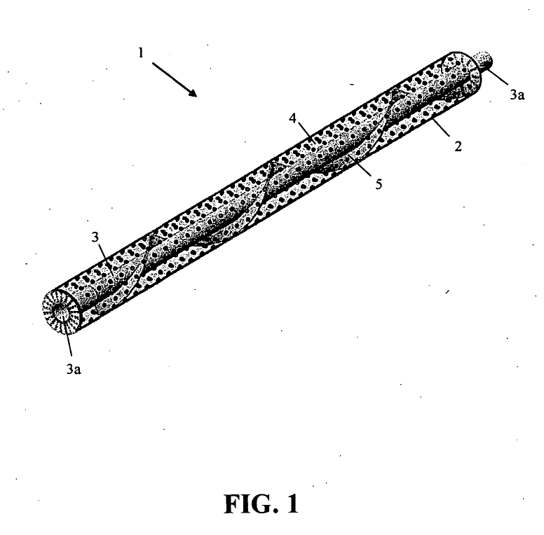

FIG. 1 shows an isometric view of a cartridge comprising contact catalyst mass which can be readily inserted in and removed from the inner pipe of the contact apparatus of the invention. Cartridge 1 comprises outer perforated tube 2 and inner hollow mandrel 3. Mandrel 3 has female and male ends 3a and 3b respectively. Contact catalyst mass 4 is located between perforated tube 2 and mandrel 3. Helical insert 5 is provided in the space between perforated tube 2 and mandrel 3 to encourage improved distribution of the gas stream flowing over the catalyst mass within.

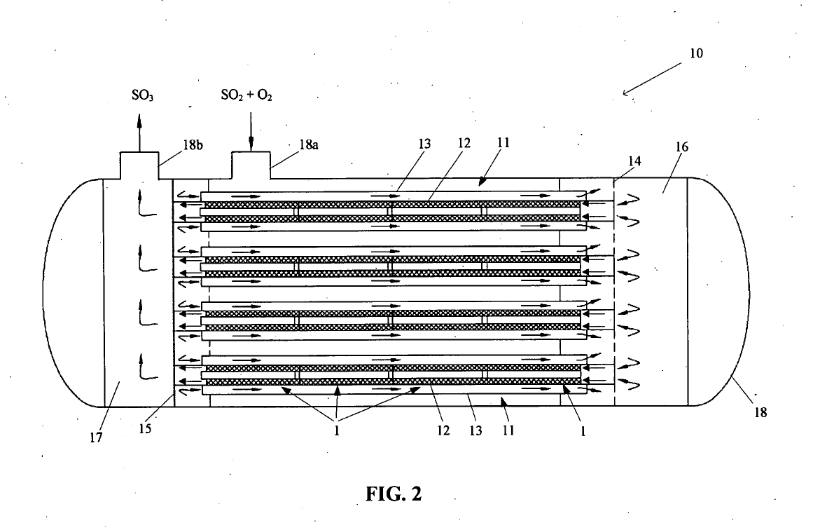

An embodiment of a contact apparatus is shown in the cross-sectional view of FIG. 2. Contact apparatus 10 comprises a plurality (four are visible) of double pipe heat exchangers 11 arranged in a parallel configuration. Each of the double pipe heat exchangers comprises inner pipe 12 and concentric outer pipe 13. Located within each inner pipe 12 are a plurality (four are shown in this figure) of cartridges 1 (similar to those shown in FIG. 1) arranged in series. To avoid clutter in FIG. 2, the individual components in cartridges 1 are not called out. As a guide to the eye, the spaces filed with catalyst material 4 are indicated by cross-hatching.

Contact apparatus 10 also comprises end plate 14 at the “cold” end, which has openings (not called out in FIG. 2) allowing fluid to flow from the exits between inner pipes 12 and outer pipes 13 to chamber 16. End plate 14 also has openings (not called out in FIG. 2) allowing fluid to flow from chamber 16 through to inner pipes 12. End plate 15 is provided at the “hot” end of contact apparatus 10 and only has openings (not called out in FIG. 2) allowing fluid to flow from the exits of inner pipes 12 to chamber 17. Finally, contact apparatus 10 has a housing 18 with gas stream inlet 18a and gas stream outlet 18b.

In FIG. 2, the flow direction of the gas stream is indicated throughout with arrows. In operation, a gas stream comprising SO₂ and O₂ is supplied to inlet 18a at an appropriate supply temperature (e.g. 130 to 250° C.). The gas stream is directed to the “hot” end of each double pipe heat exchanger and then between each pair of inner and outer pipes 12, 13. The gas stream exits from between each pair of inner and outer pipes 12, 13 at the “cold” end and flows into chamber 16. Then, the gas stream is directed through each inner pipe 12 in the plurality of double pipe heat exchangers 11 and exits into chamber 17. Finally, the gas stream exits contact apparatus 10 at outlet 18b.

The SO₂ and O₂ containing gas stream thus enters contact apparatus 10 at a temperature in the range from about 130 to 250° C. Via heat exchange, as it travels through the annular space between outer and inner pipes 12, 13, the gas stream continually cools the stream within inner pipes 12 in which catalytic oxidation is taking place. The design and operation of the contact apparatus are selected such that the gas stream is at a desired catalyst activation temperature (in the range from about 385 to 425° C.) as it exits the double pipe heat exchangers 11 and flows into chamber 16.

The gas stream then enters inner pipes 12 of double pipe heat exchangers 11 and is directed over catalyst mass 4 therein. As SO₂ in the gas stream is oxidized to SO₃, heat is generated and removed via heat exchange with the cooler gas stream surrounding it in the double pipe heat exchanger. By appropriate selection of design and operating parameters, the temperature of the exiting, SO₃ containing gas stream at outlet 18b can be in the range from about 450 to 500° C.

With the arrangement shown in FIG. 2, no separate supply of cooling air or other cooling gas is required for the oxidizing reaction. Instead, the supplied gas stream itself is used as the cooling medium.

Although not shown in FIG. 2, double pipe heat exchangers 11 can advantageously comprise helical fins and studs in the annular spaces between the inner and outer pipes in order to promote the exchange of heat.

The use of cartridges 1, in the horizontal mounting configuration shown in FIG. 2, offers several additional advantages. Spent contact catalyst material can readily be exchanged by sliding out spent cartridges horizontally (instead of lifting out) and inserting fresh ones in the reverse manner. The female and male ends 3a, 3b of hollow mandrels 3 assist in guiding and nesting adjacent cartridges together. Extraction of a cartridge can be conveniently accomplished for instance by using a suitable hooked tool which is inserted through the core of hollow mandrel 3, hooked onto the distant end of the cartridge, and pulled out, withdrawing the cartridge with it. (Although the hollow feature in mandrels 3 can primarily be for purposes of extraction and installation, those in the art will appreciate that it also provides a significant surface available for heat transfer purposes. Thus, if desired the inner surfaces of hollow mandrels 3 may be considered for heat exchange purposes as well.)

A further advantage of using a series of cartridges 1 in each double pipe heat exchanger 11 as shown in FIG. 2 is that gradients can be more readily be established in the contact catalyst mass seen by the flowing gas stream. For instance, different cartridges can comprise contact catalyst masses characterized by different parameters such as packing density, porosity, and/or catalyst size. In this way, a gradient in one or more catalyst parameters can be established in discrete steps along the length of the contact apparatus.

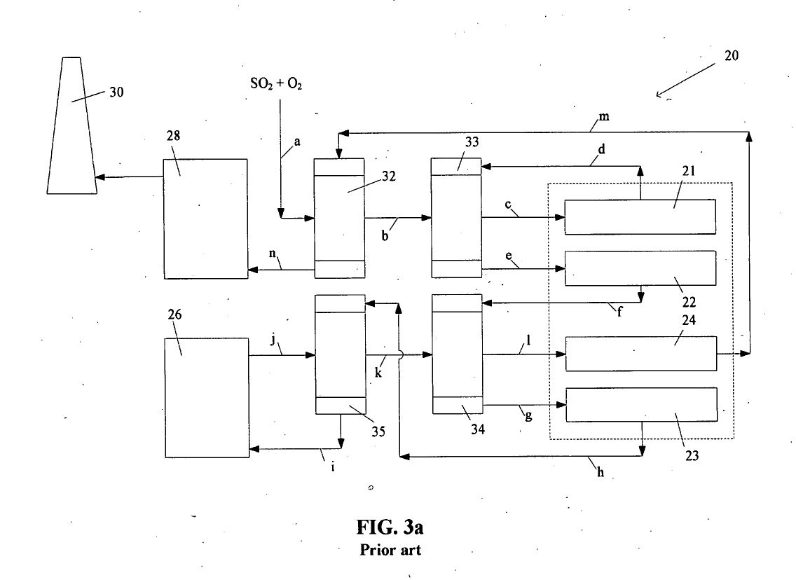

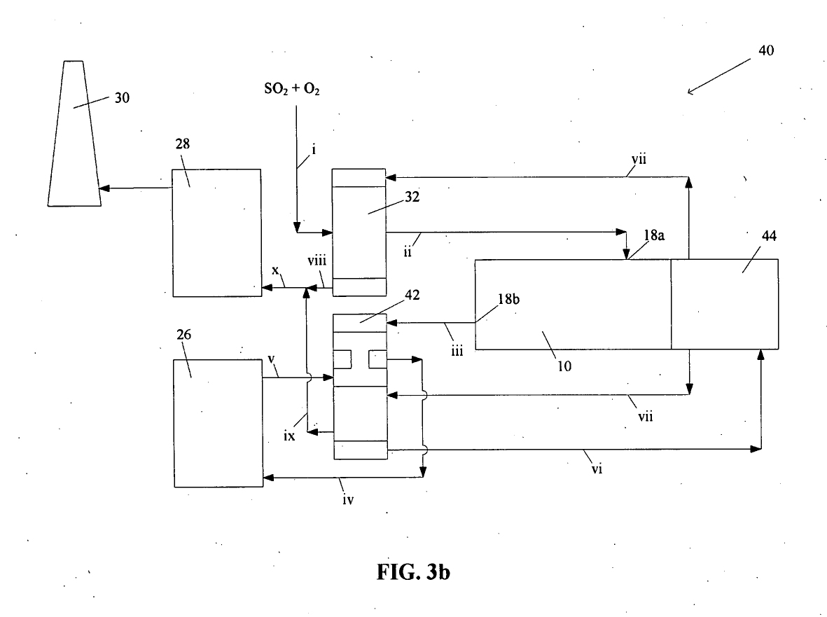

As mentioned above, use of contact apparatus 11 can allow for certain heat exchangers found in conventional systems to be omitted. To illustrate this, FIG. 3a shows a schematic of a prior art double absorption system for producing sulphuric acid, while FIG. 3b shows a schematic of a system of the invention comprising the contact apparatus of FIG. 2.

Conventional double absorption system 20 in FIG. 3a comprises four separate contact catalyst beds 21, 22, 23, and 24, each containing contact catalyst mass. System 20 also comprises two absorption towers, namely intermediate absorption tower 26 and final absorption tower 28, and output stack 30. System 30 also comprises four separate heat exchangers in order to obtain a high conversion efficiency in the overall process. These heat exchangers are denoted as cold exchanger 32, hot exchanger 33, inter reheat exchanger 34, and cold reheat exchanger 35. To avoid clutter in FIG. 3a, the separating structures within those heat exchangers shown and their various inlets and outlets have not been called out. Instead, arrows are provided on all the interconnecting lines to show the flow of the gas stream being processed. The inlets and outlets can thus be readily inferred by the direction of the arrows. As a further guide however, the temperatures of the gas stream at various locations throughout the system are indicated by small case alphabetic characters.

In brief then, the double absorption process in FIG. 3a proceeds as follows. A gas stream comprising sulfur dioxide and oxygen is provided at supply temperature a to cold exchanger 32 where heat is exchanged with the hotter gas stream at fourth catalyst bed outlet temperature m. The gas stream exits cold exchanger 32 at temperature b and is directed to hot exchanger 33 where heat is exchanged with the hotter gas stream at first catalyst bed outlet temperature d. The gas stream exits hot exchanger 33 at first catalyst inlet temperature c and is directed to first catalyst bed 21. A first oxidation of SO₂ in the gas stream takes place over catalyst bed 21 and the exiting gas stream is now at hotter first catalyst bed outlet temperature d.

After exchanging heat in hot exchanger 33, the gas stream exits at second catalyst bed inlet temperature e and is directed to second catalyst bed 22. A second oxidation of SO₂ in the gas stream takes place over catalyst bed 22 and the exiting gas stream is now at hotter second catalyst bed outlet temperature f.

The gas stream at second catalyst bed outlet temperature f is directed to inter reheat exchanger 34 where heat is exchanged with the colder gas stream exiting cold reheat exchanger 35 at temperature k. The gas stream then exits inter reheat exchanger 34 at third catalyst bed inlet temperature g and is directed to third catalyst bed 23. A third oxidation of SO₂ in the gas stream takes place over catalyst bed 23 and the exiting gas stream is now at hotter third catalyst bed outlet temperature h.

The gas stream at third catalyst bed outlet temperature h is directed to cold reheat exchanger 35 where heat is exchanged with the colder gas stream coming from intermediate absorption tower 26 at temperature j. The gas stream then exits cold reheat exchanger 35 at intermediate absorption inlet temperature i and is directed to intermediate absorption tower 26 in which a first absorption (in water) of SO₃ from the gas stream takes place. The exiting gas stream is now at a colder temperature j. The gas stream is then heated in two stages. The first stage involves exchanging heat with the gas stream at third catalyst bed outlet temperature h in cold reheat exchanger 35 to produce a gas stream exiting cold reheat exchanger 35 at temperature k. Then, the second stage involves directing the gas stream to inter reheat exchanger 34 where heat is exchanged with the hotter gas stream at second catalyst bed outlet temperature f, to produce a gas stream exiting inter reheat exchanger 34 at fourth catalyst bed inlet temperature l.

The gas stream at fourth catalyst bed inlet temperature l is next directed to fourth catalyst bed 24. A fourth oxidation of SO₂ in the gas stream takes place over catalyst bed 24 and the exiting gas stream is now at hotter fourth catalyst bed outlet temperature m.

The gas stream at fourth catalyst bed outlet temperature m is directed to cold exchanger 32 where heat is exchanged with the colder supplied gas stream at temperature a. The gas stream then exits cold exchanger 32 at final absorption inlet temperature n and is directed to final absorption tower 28 in which a second and final absorption of SO₂ from the gas stream takes place. The exiting gas stream is then discharged at stack 30.

The conventional double absorption system in FIG. 3a produces sulfuric acid with high conversion efficiency but comprises numerous external heat exchangers. Use of the inventive contact apparatus however can allow for a simplification of such a system while still maintaining high conversion efficiency. FIG. 3b shows a schematic of such a simplified system.

The simplified double absorption system 40 in FIG. 3b comprises two components in which contact catalysis takes place, namely first contact apparatus 10 (as illustrated in detail in FIG. 2) which is essentially equivalent in function to the three catalyst beds 21, 22, and 23 in FIG. 3a, and second contact apparatus 44 which is equivalent in function to catalyst bed 24 in FIG. 3a. As in the prior art system, system 40 also comprises intermediate absorption tower 26, final absorption tower 28, and output stack 30. However, system 40 now comprises only two separate external heat exchangers while maintaining the capability to obtain a high conversion efficiency in the overall process. These include cold exchanger 32 as before and also special cold reheat exchanger 42. Here, cold reheat exchanger 42 is preferably a shell and tube gas-gas heat exchanger comprising both a counter-current flow section and a co-current flow section and in which two separate hot gas streams are used in series to heat a single cold gas. In particular, cold reheat exchanger 42 can be that depicted in FIG. 3 of published international patent application number WO2011/137506 which is hereby incorporated by reference in its entirety. As in FIG. 3a, to avoid clutter in FIG. 3b, the separating structures within the heat exchangers shown and their various inlets and outlets have not been called out. Instead, arrows are provided on all the interconnecting lines to show the flow of the gas stream being processed. Here, the temperatures of the gas stream at various locations throughout the system are indicated by small case roman numerals. Unlike the prior art system of FIG. 3a though, no external heat exchangers and cooling media are required to cool the contact catalyst masses in contact apparatus 10. Instead, cooling is accomplished using the process gas stream as described above with regards to the embodiment of FIG. 2.

In brief here, the double absorption process in FIG. 3b proceeds as follows. A gas stream comprising sulfur dioxide and oxygen is provided at supply temperature i to cold exchanger 32 where heat is exchanged with the hotter gas stream at second contact apparatus outlet temperature vii. The gas stream exits cold exchanger 32 at first contact apparatus inlet temperature ii and is directed immediately to inlet 18a of first contact apparatus 10 in which oxidation of SO₂ in the gas stream takes place and heat is exchanged as described above.

The gas stream exits contact apparatus 10 at outlet 18b and at first contact apparatus outlet temperature iii. The gas stream is then directed to special cold reheat exchanger 42 where heat is exchanged with the colder gas stream coming from intermediate absorption tower 26 at temperature v in the co-current flow exchange section of cold reheat exchanger 42. The gas stream exits cold reheat exchanger 42 at intermediate absorption inlet temperature iv and is directed to intermediate absorption tower 26 in which a first absorption of SO₂ from the gas stream takes place. The exiting gas stream is now at a colder temperature v. The gas stream is then heated in two stages. The first stage involves exchanging heat with the gas stream at first contact apparatus outlet temperature iii in the co-current flow exchange section and then the second stage involves exchanging heat with the gas stream at the second contact apparatus outlet temperature vii in the counter-current exchange section of cold reheat exchanger 42 to produce a gas stream exiting cold reheat exchanger 42 at second contact apparatus inlet temperature vi.

The gas stream at second contact apparatus inlet temperature vi is next directed to second contact apparatus 44 in which another oxidation of SO₂ in the gas stream takes place. The exiting gas stream is now at hotter second contact apparatus outlet temperature vii, e.g. in the range from about 430 to 450° C. (Note:. as discussed more below, the second contact apparatus employed may be a conventional catalyst bed, and thus external heat exchanging apparatus and cooling media may be used here in order to exchange heat between the gas stream and the cooling media during the oxidation process.)

At this point, the gas stream is split into two portions. A first portion of the gas stream at second contact apparatus outlet temperature vii is directed to cold exchanger 32 where heat is exchanged with the colder supplied gas stream at temperature i. The gas stream then exits cold exchanger 32 at temperature viii, e.g. in the range from about 180 to 230° C. The remaining portion of the gas stream at second contact apparatus outlet temperature vii is directed to cold reheat exchanger 42 where it exchanges heat with the gas stream in the counter-current exchange section of cold reheat exchanger 42. This remaining portion of the gas stream exits cold reheat exchanger 42 at temperature ix and is combined with the gas stream exiting cold exchanger 32 at temperature vii to produce a combined gas stream at final absorption tower inlet temperature x. Finally, the combined gas stream is directed to final absorption tower 28 in which a second and final absorption of SO₃ from the gas stream takes place. Again, the exiting gas stream is discharged at stack 30.

By incorporating first contact apparatus 10 in place of the conventional first three catalyst beds 21, 22, 23, system 40 enjoys similar high conversion efficiency but can achieve this with fewer external heat exchangers and sources of cooling media. Second contact apparatus 44 can optionally be an externally cooled catalyst bed supporting a contact catalyst mass (e.g. like bed 24 in FIG. 3a). However, the second contact apparatus can instead also be conveniently based on a plurality of cartridges 1 in series. Specifically, the second contact apparatus can comprise a pipe or pipes containing numerous cartridges 1 in series, which is/are oriented horizontally for ease of maintenance and/or catalyst replacement. Thus, the cartridges of FIG. 1 may advantageously be employed here even though the double pipe heat exchanger of FIG. 2 is not considered necessary.

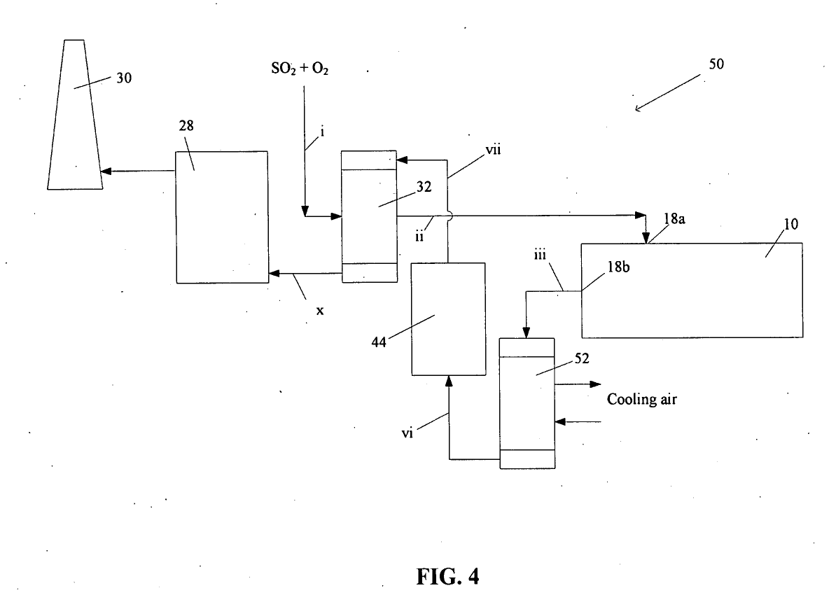

Although it can be preferable to produce sulfuric acid using a double absorption contact process to obtain the highest conversion efficiency possible, the contact apparatus of the invention can also benefit systems based on a single absorption contact process. For example, FIG. 4. shows a schematic of a single absorption system of the invention for producing sulphuric acid, in which the system comprises the contact apparatus of FIG. 2.

In FIG. 4, single absorption system 50 comprises cold exchanger 32, first contact apparatus 10 (as in FIG. 2), sulfur trioxide cooler 52, second contact apparatus 44, absorption tower 28, and stack 30. Note that these system components can be similar in function and construction as those in the double absorption system of FIG. 3b with the exception of sulfur trioxide cooler 52. A preferred design for the sulfur trioxide cooler component is that disclosed in FIG. 14 in “Improve Gas-Gas Exchanger Reliability Through Technical Innovation”, O. Perez, International Conference & Exhibition SULFUR 2010, Nov. 1-4, 2010, Prague Hilton, Czech Republic, which is hereby incorporated by reference in its entirety.

In brief here, the single absorption process in FIG. 4 proceeds as follows. (Note that like numerals and roman numerals have been used to indicate certain components and stream temperatures that are qualitatively similar to those of FIG. 3b. However, the preferred components, and particularly the stream temperatures may differ in detail and range from those of FIG. 3b.) As before, a gas stream comprising sulfur dioxide and oxygen is provided at supply temperature i to cold exchanger 32 where heat is exchanged with the hotter gas stream at second contact apparatus outlet temperature vii. The gas stream exits cold exchanger 32 at first contact apparatus inlet temperature ii and is directed immediately to inlet 18a of first contact apparatus 10 in which oxidation of SO₂ in the gas stream takes place and heat is exchanged as described before.

The gas stream exits contact apparatus 10 at outlet 18b and at first contact apparatus outlet temperature iii. The gas stream is then directed to sulfur trioxide cooler 52 where heat is exchanged with an external supply of cooling air, and the gas stream exits sulfur trioxide cooler 52 at second contact apparatus inlet temperature vi.

The gas stream at second contact apparatus inlet temperature vi is next directed to second contact apparatus 44 in which another oxidation of SO₂ in the gas stream takes place. The exiting gas stream is now at hotter second contact apparatus outlet temperature vii. (Note: as before, the second contact apparatus employed may be a conventional catalyst bed, and thus external heat exchanging apparatus and cooling media may be used here in order to exchange heat between the gas stream and the cooling media during the oxidation process.) The gas stream at second contact apparatus outlet temperature vii is directed to cold exchanger 32 where heat is exchanged with the colder supplied gas stream at temperature i. The gas stream then exits cold exchanger 32 at absorption tower inlet temperature x in which absorption of SO₃ from the gas stream takes place. And then, the exiting gas stream is discharged at stack 30.

In comparison to a conventional single absorption system comprising four catalyst beds, first contact apparatus 10 can be viewed as replacing the first three catalyst beds, while second contact apparatus 44 functions as the fourth catalyst bed. Further, system 50 does not require the conventional inter reheat exchanger nor the conventional hot exchanger which are also used in prior art single absorption systems. As before, second contact apparatus 44 can optionally be an externally cooled catalyst bed or conveniently, a set of pipes containing numerous cartridges 1 in series.

While the preceding descriptions represent desirable embodiments of the invention, it will readily be apparent to those in the art that other configurations employing the above inventive contact apparatus and/or cartridges are possible. For instance, it is possible to retrofit existing prior art double or single absorption systems with either or both of these.

The following Example has been. included to illustrate certain aspects of the invention but should not be construed as limiting in any way.

### EXAMPLE

Modeling was performed to compare the temperature and sulphur dioxide conversion characteristics expected for an exemplary comparative sulphuric acid production system of the prior art to a system of the invention. In this regard, embodiments as depicted generally in FIGS. 3a and 3b for the comparative and inventive systems respectively were assumed. Further, in the inventive system, embodiments as depicted generally in FIGS. 2 and 1 were assumed for the first contact apparatus and the series of cartridges therein respectively. Also certain reasonable assumptions were made regarding rates of oxidation and heat transfer (based on typical catalyst properties, the properties of materials typically used in construction, and operating conditions).

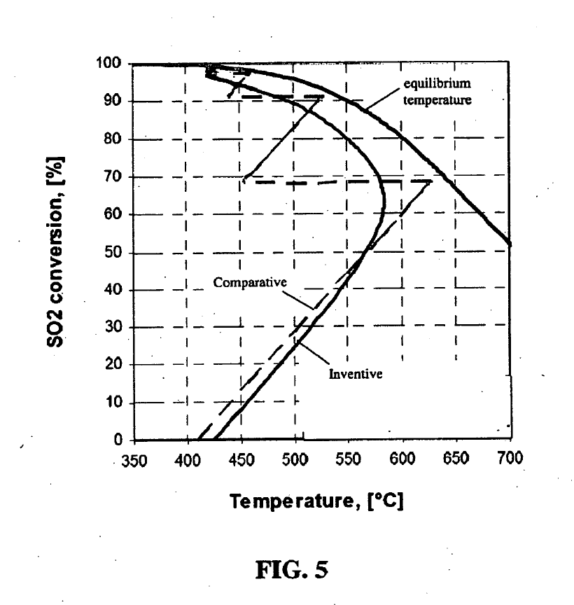

FIG. 5 compares the gas stream temperatures and associated sulphur dioxide conversion characteristics for the gas streams in the comparative (denoted Comparative) and inventive (denoted Inventive) systems. The equilibrium temperature is also provided in FIG. 5. In the Comparative system, the discrete exothermic heating events in the catalyst beds followed by a cooling external to the beds result in the sawtooth profile shown in FIG. 5. Certain temperatures of the gas stream in FIG. 3a are also presented in FIG. 5 for comparison. (Note: the profile in FIG. 5 also includes the characteristics associated with the second contact apparatus in each embodiment at the top of the plot. However, these are difficult to resolve at the scale in this figure.) The characteristics of the Inventive system are comparable to, but smoother than, those of the Comparative system and are well within an acceptable range for an efficient double contact conversion process.

All of the above U.S. patents, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

1. A method of oxidizing sulfur dioxide in a gas stream comprising sulfur dioxide and oxygen at a supply temperature, the method comprising:
providing a first contact apparatus comprising a double pipe heat exchanger comprising:
an inner pipe comprising a first contact catalyst mass, and
an essentially concentric outer pipe;
exchanging heat with the gas stream to adjust the gas stream to a first contact apparatus inlet temperature;
flowing the gas stream between the inner and outer pipes of the double pipe heat exchanger; and
collecting the gas stream exiting from between the inner and outer pipes and flowing the gas stream countercurrently through the inner pipe of the double pipe heat exchanger,
wherein the gas stream is the cooling medium for the first contact apparatus and is heated to a catalyst activation temperature as it flows between the inner and outer pipes and is heated to a first contact apparatus outlet temperature as it flows through the inner pipe; and whereby a portion of the sulfur dioxide in the inner pipe is oxidized to sulfur trioxide.

2. The method of claim 1 wherein the supply temperature is in the range from about 130 to 250° C.

3. The method of claim 1 wherein the first contact apparatus inlet temperature is in the range from about 130 to 250° C.

4. The method of claim 1 wherein the catalyst activation temperature is in the range from about 385 to 425° C.

5. The method of claim 1 wherein the first contact apparatus outlet temperature is in the range from about 450 to 500° C.

6. A single absorption process for oxidizing sulfur dioxide to produce sulfuric acid comprising:
providing a gas stream comprising sulfur dioxide and oxygen at a supply temperature;
oxidizing sulfur dioxide in the gas stream according to the method of claim 1 wherein heat is exchanged between the gas stream and a cold exchanger gas in a cold exchanger in the exchanging heat step;
exchanging heat between the gas stream at the first contact apparatus outlet temperature and a sulfur trioxide cooler gas in a sulfur trioxide cooler wherein the gas stream is cooled to a second contact apparatus inlet temperature;
oxidizing the sulfur dioxide in the gas stream at the second contact apparatus inlet temperature in a second contact apparatus comprising a second contact catalyst mass, wherein sulfur dioxide in the second contact apparatus is oxidized to sulfur trioxide, and the gas stream is heated to a second contact apparatus outlet temperature;
exchanging heat between the gas stream at the second contact apparatus outlet temperature and the gas stream at the supply temperature in the cold exchanger wherein the gas stream at the second contact apparatus outlet temperature is the cold exchanger gas, thereby cooling the portion of the gas stream to an absorption tower inlet temperature;
directing the gas stream at the absorption tower inlet temperature to an absorption tower wherein sulfur trioxide in the combined gas stream is absorbed in water to produce sulfuric acid; and
exhausting the gas stream.

7. The single absorption process of claim 6 wherein the process involves no additional heat exchanging steps in additional heat exchangers.

8. A double absorption process for oxidizing sulfur dioxide to produce sulfuric acid comprising:
providing a gas stream comprising sulfur dioxide and oxygen at a supply temperature;
oxidizing sulfur dioxide in the gas stream according to the method of claim 1 wherein heat is exchanged between the gas stream and a cold exchanger gas in a cold exchanger in the exchanging heat step;
exchanging heat between the gas stream at the first contact apparatus outlet temperature and a cold reheat exchanger gas in a cold reheat exchanger wherein the gas stream is cooled to an intermediate absorption tower inlet temperature;
directing the gas stream at the intermediate absorption tower inlet temperature to an intermediate absorption tower wherein sulfur trioxide in the gas stream is absorbed in water to produce sulfuric acid and the gas stream is cooled to an intermediate absorption tower outlet temperature;
exchanging heat between the gas stream at the intermediate absorption tower outlet temperature and both the gas stream at the first contact apparatus outlet temperature and the gas stream at a second contact apparatus outlet temperature in the cold reheat exchanger wherein the gas stream at the intermediate absorption tower outlet temperature is the cold reheat exchanger gas, thereby heating the gas stream to a second contact apparatus inlet temperature;
oxidizing the sulfur dioxide in the gas stream at the second contact apparatus inlet temperature in a second contact apparatus comprising a second contact catalyst mass, wherein sulfur dioxide in the second contact apparatus is oxidized to sulfur trioxide, and the gas stream is heated to the second contact apparatus outlet temperature;
exchanging heat between a portion of the gas stream at the second contact apparatus outlet temperature and the gas stream at the supply temperature in the cold exchanger wherein the portion of the gas stream at the second contact apparatus outlet temperature is the cold exchanger gas, thereby cooling the portion of the gas stream to a cooled portion temperature;
exchanging heat between the remaining portion of the gas stream at the second contact apparatus outlet temperature and the gas stream at the intermediate absorption tower outlet temperature in the cold reheat exchanger, thereby cooling the remaining portion of the gas stream to a cooled remaining portion temperature;
combining the portion of the gas stream at the cooled portion temperature and the remaining portion of the gas stream at the cooled remaining portion temperature wherein the combined gas stream is at a final absorption tower inlet temperature;
directing the combined gas stream at the final absorption tower inlet temperature to a final absorption tower wherein sulfur trioxide in the combined gas stream is absorbed in water to produce sulfuric acid; and
exhausting the gas stream.

9. The double absorption process of claim 8 wherein the process involves no additional heat exchanging steps in additional heat exchangers.

10. The double absorption process of claim 8 wherein both the portion and the remaining portion of the gas stream at the second contact apparatus outlet temperature is in the range from about 410 to 450° C.

11. The double absorption process of claim 8 wherein the portion of the gas stream at the cooled portion temperature is in the range from about 180 to 230° C.

12. A contact apparatus comprising a double pipe heat exchanger comprising an inner pipe comprising a contact catalyst mass, and an essentially concentric outer pipe, wherein the contact apparatus is configured to operate according to the method of claim 1.

13. The contact apparatus of claim 12 wherein the double pipe heat exchanger comprises helical fins and studs between the inner and outer pipes.

14. The contact apparatus of claim 12 wherein the inner pipe of the double pipe heat exchanger comprises a plurality of cartridges in series wherein the cartridges comprise the contact catalyst mass.

15. The contact apparatus of claim 14 wherein each cartridge comprises an outer perforated tube and an inner hollow mandrel wherein the contact catalyst mass is located between the perforated tube and the mandrel.

16. The contact apparatus of claim 15 wherein each cartridge comprises a helical insert between the perforated tube and the mandrel.

17. The contact apparatus of claim 14 wherein the contact catalyst masses in different cartridges from the plurality of cartridges are characterized by a different parameter selected from the group consisting of packing density, porosity, and catalyst size.

18. The contact apparatus of claim 12 comprising a plurality of double pipe heat exchangers.

19. The contact apparatus of claim 18 wherein the plurality of double pipe heat exchangers are arranged in parallel.

20. A system for oxidizing sulfur dioxide to produce sulfuric acid comprising a cold exchanger, a first contact apparatus comprising a first contact catalyst mass, a sulfur trioxide cooler, a second contact apparatus comprising a second contact catalyst mass, and an absorption tower, wherein the system is configured to operate according to the single absorption process of claim 6.

21. A system for oxidizing sulfur dioxide to produce sulfuric acid comprising a cold exchanger, a first contact apparatus comprising a first contact catalyst mass, a cold reheat exchanger, an intermediate absorption tower, a second contact apparatus comprising a second contact catalyst mass, and a final absorption tower, wherein the system is configured to operate according to the double absorption process of claim 8.

22. The system of claim 21 wherein the second contact apparatus comprises a bed supporting the second contact catalyst mass.

23. The system of claim 21 wherein the second contact apparatus comprises a pipe comprising a plurality of cartridges in series wherein the cartridges comprise the second contact catalyst mass.

24. The system of claim 21 wherein the first contact apparatus is oriented horizontally.

25. The system of claim 21 wherein the cold reheat exchanger comprises a shell and tube heat exchanger comprising a co-current flow section for the heat exchanging of the gas stream at the first contact apparatus outlet temperature and a counter-current flow section for the heat exchanging of the remaining portion of the gas stream at the second contact apparatus outlet temperature.

26. The system of claim 20 wherein the first contact apparatus is oriented horizontally.
